(19) United States
(12) Patent Application Publication
(10) Pub. No.: US 2011/0184670 A1
(43) Pub. Date: Jul. 28, 2011

(54) PIPELINE LEAK DETECTION SYSTEM AND METHOD

(75) Inventors: Chi-Chih WANG, Tu-Cheng (TW); Bing-Yu HE, Shenzhen City (CN); Zhong-Gen ZHAN, Shenzhen City (CN); Zhong-Dan XU, Shenzhen City (CN); Shi-Liu LIU, Shenzhen City (CN); Jing LIAO, Shenzhen City (CN)

(73) Assignees: GDS SOFTWARE (SHENZHEN) CO.,LTD, ShenZhen City (CN); HON HAI PRECISION INDUSTRY CO., LTD., Tu-Cheng (TW)

(21) Appl. No.: 12/915,010

(22) Filed: Oct. 29, 2010

(30) Foreign Application Priority Data
Jan. 27, 2010 (CN) 201010300810.0

(51) Int. Cl. G01M 3/28

(52) U.S. Cl. 702/51

(57) ABSTRACT

In a pipeline leak detection system and method, a data collection frequency of a pipeline network is set. Pipeline monitoring data of the pipeline network is obtained according to the data collection frequency. Leak locations along the pipeline network are identified according to the pipeline monitoring data. The leak locations along the pipeline network are notified to users.

### BACKGROUND

1. Technical Field

Embodiments of the present disclosure relate to leak detection technology, and particularly to a system and method for detecting leaks that occur in a pipeline network.

2. Description of Related Art

Pipeline leaks happen frequently. The pipeline leaks cause a serious waste of resources. There are many pipeline leak detection methods. The simplest method involves walking the pipeline right-of-way to inspect the leaks. However, the current methods may be time consuming or imprecise.

### BRIEF DESCRIPTION OF THE DRAWINGS

FIG. 1 is one embodiment of an application of a pipeline leak detection system.

FIG. 2 is a block diagram of one embodiment of a leak detection unit in FIG. 1.

FIG. 3 is a flowchart of one embodiment of a pipeline leak detection method implementing a detection system, such as that in FIG. 1.

FIG. 4 illustrates one example of sensors installed in a pipeline network.

### DETAILED DESCRIPTION

In general, the word “module,” as used hereinafter, refers to logic embodied in hardware or firmware, or to a collection of software instructions, written in a programming language, such as, for example, Java, C, or Assembly. One or more software instructions in the modules may be embedded in firmware. It will be appreciated that modules may comprised connected logic units, such as gates and flip-flops, and may comprise programmable units, such as programmable gate arrays or processors. The modules described herein may be implemented as either software and/or hardware modules and may be stored in any type of computer-readable medium or other computer storage device.

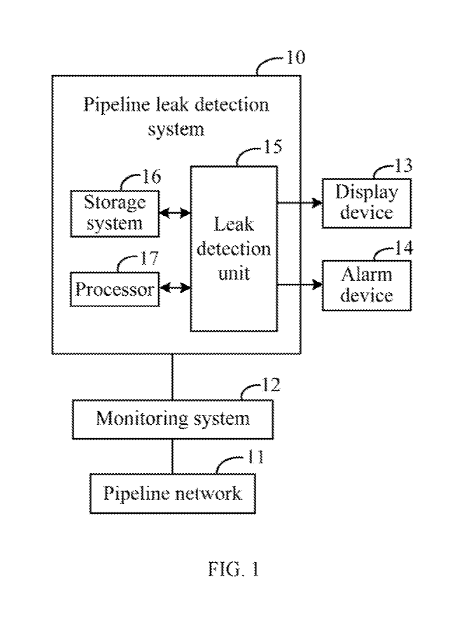

FIG. 1 is one embodiment of an application of a pipeline leak detection system 10. The detection system 10 detects leaks occurring in a pipeline network 11 that transports fluid such as oil, gas, or water, for example. In one embodiment, the detection system 10 is connected to a monitoring system 12. The monitoring system 12 may include sensors (e.g., flow meters and pressure sensors) that collects pipeline monitoring data (e.g., flow rates and fluid pressures) of the pipeline network 11. The detection system 10 may be further connected to a display device 13 (e.g., a display screen) and an alarm device 14 (e.g., a buzzer or a warming light) for notifying users of the leaks. The detection system 10 may be a data processing device or a computerized device such as a personal computer, an application server, or a workstation, for example.

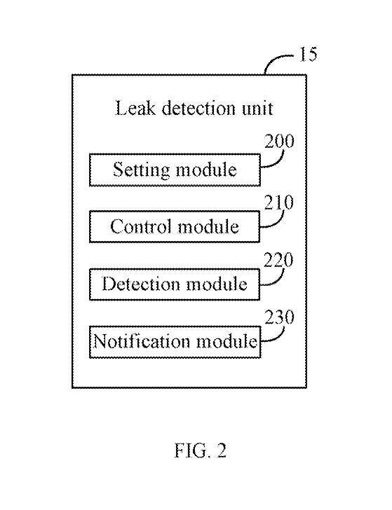

In one embodiment, the detection system 10 includes a leak detection unit 15, a storage system 16, and at least one processor 17. The leak detection unit 15 includes a number of function modules (detailed description is given in FIG. 2). The function modules may comprise computerized code in the form of one or more programs that are stored in the storage system 16. The computerized code includes instructions that are executed by the at least one processor 17 to provide functions for the modules. The storage system 16 may be a memory, a hard disk driver, or a cache.

FIG. 2 is a block diagram of one embodiment of the leak detection unit 15 in FIG. 1. In one embodiment, the leak detection unit 15 includes a setting module 200, an obtaining module 210, a detection module 220, and a notification module 230.

The setting module 200 sets a data collection frequency of the pipeline network 11. The data collection frequency refers to a time interval at which pipeline monitoring data of the pipeline network 11 are collected. In one example, the data collection frequency is set as every 5 minutes.

The obtaining module 210 obtains pipeline monitoring data (e.g., flow rates and fluid pressures) of the pipeline network 11 according to the data collection frequency. In one embodiment, the obtaining module 210 controls sensors of the monitoring system 12 to collect the pipeline monitoring data of the pipeline network 11 at the data collection frequency. The sensors may be installed in the pipeline network 11 at different locations.

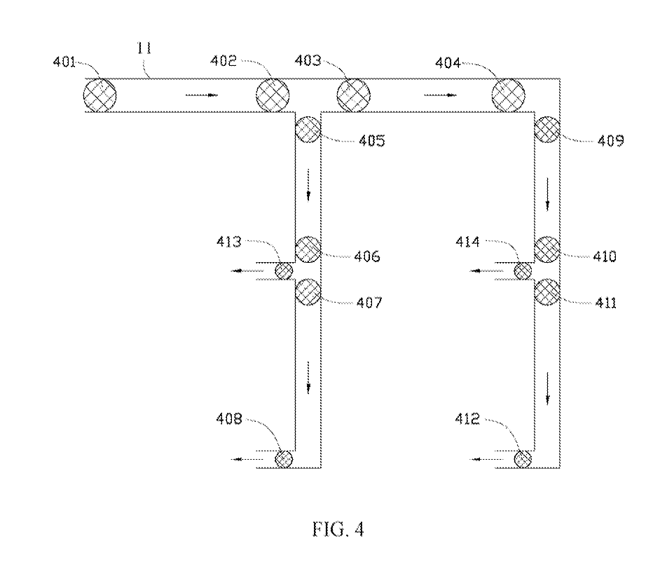

FIG. 4 illustrates one example of sensors 401-414 installed in the pipeline network 11. The sensors 401-414 collect the pipeline monitoring data of the pipeline network 11 such as flow rates and fluid pressures. Each of the sensors 401-414 may include a communication unit such as a radio transceiver, for communicating with the detection system 10.

The detection module 220 analyzes the pipeline monitoring data to identify leak locations along the pipeline network 11. In one embodiment, the pipeline monitoring data of the pipeline network 11 include flow rates and fluid pressures along different locations of the pipeline network 11. The detection module 220 may analyze the flow rates to identify leaking pipeline sections of the pipeline network 11. In addition, the detection module 220 analyzes the fluid pressures to identify the leak locations along the leaking pipeline sections. A pipeline section may be known as a part of the pipeline network 11, such as a pipeline section between the sensors 401 and 402. Further details will be described below.

The notification module 230 notifies users of the leak locations along the pipeline network 11. In one embodiment, the notification module 230 may generate a monitoring image of the pipeline network 11 and mark the leak locations in the monitoring image. In addition, the notification module 230 may display the monitoring image of the pipeline network 11 on the display device 13.

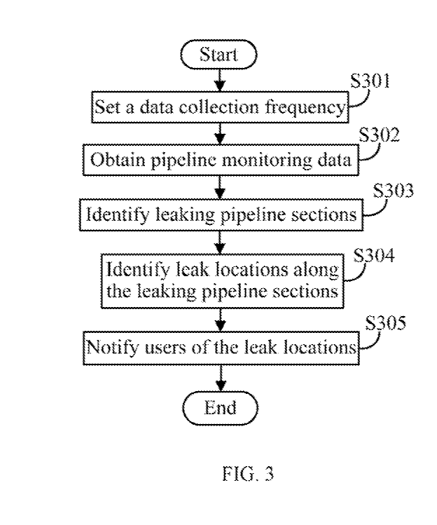

FIG. 3 is a flowchart of one embodiment of a pipeline leak detection method implementing a detection system, such as that in FIG. 1. The method may be used to detect leaks occurring in the pipeline network 11. Depending on the embodiments, additional blocks may be added, others removed, and the ordering of the blocks may be changed.

In block S301, the setting module 200 sets a data collection frequency of the pipeline network 11. In one example, the data collection frequency is set as every 5 minutes.

In block S302, the obtaining module 210 obtains pipeline monitoring data of the pipeline network 11 according to the data collection frequency. In one embodiment, the obtaining module 210 controls the monitoring system 12 to collect the pipeline monitoring data of the pipeline network 11 at the data collection frequency. As mentioned above, the monitoring system 12 may include sensors installed in the pipeline network 11. Each sensor may be equipped with a communication unit such as a radio transceiver for communicating with the detection system 10. In one example, the obtaining module 210 sends data collection instructions to the sensors according to the data collection frequency. Upon receiving the data collection instructions from the obtaining module 210, the sensors collect and transmit the pipeline monitoring data of the pipeline network 11 to the detection system 10.

In one example with respect to FIG. 4, sensors 401-414 are installed along different locations of the pipeline network 11. Each of the sensors 401-414 measures a flow rate and a fluid pressure along the pipeline network 11. For example, the sensor 401 obtains a first flow rate (Q1) and a first fluid pressure of (P1). The sensor 402 obtains a second flow rate (Q2) and a second fluid pressure (P2). The sensor 414 obtains a fourteenth flow rate (Q14) and a fourteenth fluid pressure (P14).

In block S303, the detection module 220 identifies leaking pipeline sections of the pipeline network 11 according to the pipeline monitoring data. A pipeline section is a part of the pipeline network 11. In one embodiment, the detection module 220 analyzes the flow rates of the pipeline network 11 to determine the leaking pipeline sections of the pipeline network 11. In one example with respect to FIG. 4, if no leaks occur in the pipeline network 11, the flow rates Q1-Q14 satisfy equations: Q1=Q2, Q3=Q4=Q9=Q10, Q5=Q6, Q7=Q8, Q11=Q12, Q1=Q3+Q5, Q5=Q7+Q13, and Q9=Q11+Q14. If any of the equations are not satisfied, leaking pipeline sections of the pipeline network 11 are identified. For example, if Q1≠Q2, a pipeline section between sensors 401 and 402 is determined being a leaking pipeline section.

In block S304, the detection module 220 identifies leak locations along the leaking pipeline sections according to the pipeline monitoring data. In one embodiment, the detection module 220 analyzes the fluid pressures of the leaking pipeline sections to determine the leak locations along the leaking pipeline sections. The detection module 220 may identify negative pressure waves generated in the leaking pipeline sections according to the fluid pressures. In addition, the detection module 220 determines the leak locations along the leaking pipeline sections according to the identified negative pressure waves. In one embodiment, one example of a formula to determine a leak location of a leak point in a leaking pipeline section may be: x=(L−aΔt) 12. In the formula, L is the length of the leaking pipeline section, x is a distance between a start point of the leaking pipeline section and the leak point, a is a propagation velocity of the negative pressure wave in the leaking pipeline section, Δt is a time difference of receiving the negative pressure wave between the start point and an end point of the leaking pipeline section.

In block S305, the notification module 230 notifies users of the leak locations along the pipeline network 11. In one embodiment, the notification module 230 may generate a monitoring image of the pipeline network 11 and mark the leak locations in the monitoring image. The notification module 230 displays the monitoring image on the display device 13. Depending on the embodiment, the notification module 230 may send an alarm to the users via the alarm device 14, e-mails, or short message service (SMS) messages.

Although certain inventive embodiments of the present disclosure have been specifically described, the present disclosure is not to be construed as being limited thereto. Various changes or modifications may be made to the present disclosure without departing from the scope and spirit of the present disclosure.

What is claimed is:

1. A pipeline leak detection system, the system comprising:
a storage system;
at least one processor;
a leak detection unit comprising one or more computerized codes, which are stored in the storage system and executable by the at least one processor, the one or more computerized codes comprising:
a setting module operable to set a data collection frequency of a pipeline network monitored by the pipeline leak detection system;
an obtaining module operable to obtain pipeline monitoring data of the pipeline network according to the data collection frequency;
a detection module operable to analyze the pipeline monitoring data to identify leak locations along the pipeline network; and
a notification module operable to notify users of the leak locations along the pipeline network.

2. The system of claim 1, wherein the pipeline monitoring data comprise flow rates and fluid pressures along different locations of the pipeline network.

3. The system of claim 2, wherein the detection module analyzes the flow rates of the pipeline network to determine leaking pipeline sections of the pipeline network, and analyzes the fluid pressures of the leaking pipeline sections to determine the leak locations along the leaking pipeline sections.

4. The system of claim 1, wherein the obtaining module controls a monitoring system comprising a plurality of sensors installed in the pipeline network to obtain the pipeline monitoring data of the pipeline network.

5. The system of claim 1, wherein the notification module generates a monitoring image of the pipeline network, marks the leak locations in the monitoring image, and displays the monitoring image on a display device connected to the system.

6. A computer-based pipeline leak detection method, the method comprising:
setting a data collection frequency of a pipeline network;
obtaining pipeline monitoring data of the pipeline network according to the data collection frequency;
analyzing the pipeline monitoring data to identify leak locations along the pipeline network; and
notifying users of the leak locations along the pipeline network.

7. The method of claim 6, wherein the pipeline monitoring data comprise flow rates and fluid pressures along different locations of the pipeline network.

8. The method of claim 7, wherein the leak locations along the pipeline network are identified by:
analyzing the flow rates of the pipeline network to determine leaking pipeline sections of the pipeline network; and
analyzing the fluid pressures of the leaking pipeline sections to determine the leak locations along the leaking pipeline sections.

9. The method of claim 6, wherein the pipeline monitoring data of the pipeline network are obtained by a monitoring system comprising a plurality of sensors installed in the pipeline network.

10. The method of claim 6, wherein the leak locations are marked in a monitoring image of the pipeline network to notify the users of the leak locations along the pipeline network.

11. A non-transitory computer-readable medium having stored thereon instructions that, when executed by a computerized device, causes the computerized device to execute a pipeline leak detection method, the method comprising:
setting a data collection frequency of a pipeline network;
obtaining pipeline monitoring data of the pipeline network according to the data collection frequency;
analyzing the pipeline monitoring data to identify leak locations along the pipeline network; and
notifying users of the leak locations along the pipeline network.

12. The computer-readable medium of claim 11, wherein the pipeline monitoring data comprise flow rates and fluid pressures along different locations of the pipeline network.

13. The computer-readable medium of claim 12, wherein the leak locations along the pipeline network are identified by:
analyzing the flow rates of the pipeline network to determine leaking pipeline sections of the pipeline network; and
analyzing the fluid pressures of the leaking pipeline sections to determine the leak locations along the leaking pipeline sections.

13. The computer-readable medium of claim 11, wherein the leak locations along the pipeline network are identified as follows:
analyzing the flow rates of the pipeline network to determine leaking pipeline sections of the pipeline network; and
analyzing the fluid pressures of the leaking pipeline sections to determine the leak locations along the leaking pipeline sections.

14. The computer-readable medium of claim 11, wherein the pipeline monitoring data of the pipeline network are obtained by a monitoring system comprising a plurality of sensors installed in the pipeline network.

15. The computer-readable medium of claim 11, wherein the leak locations are marked in a monitoring image of the pipeline network to notify the users of the leak locations along the pipeline network.
